(19) United States
(12) Patent Application Publication
(10) Pub. No.: US 2012/0163560 A1
(43) Pub. Date: Jun. 28, 2012

(54) EMERGENCY COMMUNICATIONS CONTROLLER AND PROTOCOL

(75) Inventor: Shelia Jean BURGESS, Haymarket, VA (US)

(73) Assignee: Azos Al, LLC, Haymarket, VA (US)

(21) Appl. No.: 13/330,310

(22) Filed: Dec. 19, 2011

Related U.S. Application Data
(63) Continuation-in-part of application No. 11/749,572, filed on May 16, 2007.
Application No. 11/749,572 is a continuation-in-part of application No. 11/968,509, filed on Jan. 2, 2008.
Application No. 11/968,509 is a continuation-in-part of application No. 11/281,198, filed on Nov. 16, 2005, now abandoned.
Application No. 11/281,198 is a continuation of application No. 10/056,246, filed on Jan. 24, 2002, now abandoned.
Application No. 10/056,246 is a continuation-in-part of application No. 09/293,041, filed on Apr. 16, 1999, now Pat. No. 6,359,970.
(60) Provisional application No. 60/103,653, filed on Oct. 9, 1998.
(60) Provisional application No. 60/096,594, filed on Aug. 14, 1998.

(51) Int. Cl. H04M 11/04

(52) U.S. Cl. 379/37

(57) ABSTRACT

A communications controller and protocol are provided for empowering the user of a communications device, such as a telephone or mobile device, to assume intelligent control of communications. The communications controller provides conditional processing of incoming communication from a plurality of conditions comprising at least an emergency condition and a normal condition. Each caller is identified by unique originating source criteria associated with an incoming communication type. The user of the device may select to block a caller based on identification and the conditional type of the communication. The user also selects if the device is put into a unique mode where only emergency communication can alert the user. While in this mode “normal” communication will not alert the user of the communications device. Sensor data such as location of the sending device may be provided to the receiving party.

### CROSS-REFERENCE TO RELATED APPLICATIONS

This application is a continuation-in-part of U.S. patent application Ser. No. 11/749,572, filed May 16, 2007. This application is further a continuation-in part of U.S. patent application Ser. No. 11/968,509, filed Jan. 2, 2008, which is a continuation-in-part of U.S. patent application Ser. No. 11/281,198 filed Nov. 16, 2005, which is now abandoned, which is a continuation of U.S. patent application Ser. No. 10/056,246, filed Jan. 24, 2002, which is now abandoned, which is a Continuation-in-part of U.S. patent application Ser. No. 09/293,041, filed Apr. 16, 1999, which is Patented as U.S. Pat. No. 6,359,970, which claims priority to U.S. Provisional Patent Application No. 60/103,653, filed Oct. 9, 1998, which is now expired, and to U.S. Provisional Patent Application No. 60/096,594, filed Aug. 14, 1998, which is now expired. The disclosure of each of the applications referenced above is hereby incorporated by reference in its entirety.

### COPYRIGHT NOTICE

This patent document contains information and material subject to copyright protection. The copyright owner has no objection to the facsimile reproduction by anyone of the patent document or the patent disclosure, as it appears in the U.S. Patent and Trademark Office files or records, but otherwise reserves all copyright rights whatsoever.

### FIELD OF THE INVENTION

An emergency communications controller and protocol are provided for empowering the user of a communications device, such as a telephone or mobile device, to assume intelligent control of communications. The communications controller provides conditional processing of incoming communication from a plurality of conditions comprising at least an emergency condition and a normal condition. Each caller is identified by unique originating source criteria associated with an incoming communication type. The user of the device may select to block a caller based on identification and the conditional type of the communication. The user also selects if the device is put into a unique mode where only emergency communication can alert the user. While in this mode “normal” communication will not alert the user of the communications device. Sensor data such as location of the sending device may be provided to the receiving party.

### BACKGROUND OF THE INVENTION

The inventive subject matter relates in general to apparatus and method for controlling communications devices. More particularly, the inventive subject matter relates to apparatus and method for permitting a user to exercise intelligent conditional control of incoming communications supplied to a communications device such as a telephone, or a mobile device in a specific example.

Today's communications user is being constantly bombarded and sometimes harassed by an ever-increasing volume of untimely and unwanted incoming communications, such as phone calls and messages, such as emails, Short Message Service (“SMS”) text messages, Instant Messages (“IMs”), etc., including solicitations. Fundamentally, some incoming communication is not desired at all while others are extremely urgent and important as in the case of receiving an emergency communication from a loved one that needs your help immediately and that might be in a panic situation! The party receiving an emergency communication needs a way of distinguishing these communications to respond immediately. Right now, all communication, whether it is a normal call or an emergency, all ring the receiving communication device the same way—a special alert is needed to let the receiving party know the condition of the incoming communication.

It is very desirable to provide telephone users, especially mobile device users, with the capability of limiting their exposure to unwanted communications at the user's option and to provide smart communication solutions with the capability of distinguishing the criticality of incoming communications—to know that they should not just let the call go to voicemail, but take the call immediately, especially in an emergency situation. This situational awareness or conditional communication is needed to stay connected to loved ones when seconds count. The world in which we live is dangerous, filled with natural and manmade disasters, even our schools are unsafe. We cannot predict when and where we will be when either we have an emergency situation and need help immediately or when someone else desperately needs us.

There exists a need for enterprise-to-person and person-to-person intelligent emergency communications using conditional processing. Not all emergencies are suited for calling 911, especially when they are an emergency of a personal nature. One conventional approach to this problem is the combined telephone/answering machine which permits the user to listen to the caller and then make a real time decision as to whether or not to pick up the telephone receiver and engage the caller. This is referred to as “call screening” in its most basic form. Of course, the user also has the option of listening to the caller's message at a later time and then making a decision as to whether or not to call back. The response generated by this approach could be very untimely in a critical situation. Also, this approach would not be effective if the receiving party is in an environment that requires their attention, for example in a meeting, theater, etc. where they are required to turn their cell phones “off”, so they will most likely let their answering service take the call. Having a device mode that only lets emergency communication alert the user would be helpful in these environments/situations so the user can “stay available” in case of an emergency.

Another method of limiting the user's exposure to unwanted phone calls is described in U.S. Pat. No. 5,060,255 to Brown entitled “Telecommunications System With Timed-Do-Not-Disturb”. This patent discloses a telephone system that enables a subscriber to designate time periods during which no incoming calls are to be received over the subscriber line. Any calls dialed to the subscriber directory number at such times are diverted to a voice response unit that issues an appropriate announcement to inform the caller of the unavailability of the dialed number station. This timed call block feature is implemented in the telephone company's central office or switching facility.

Another call screening approach is disclosed in U.S. Pat. No. 5,467,388 issued to Redd, Jr. et al. entitled “Method And Apparatus For Selectively Blocking Incoming Telephone Calls”. In that patent, a system is disclosed for allowing a telephone subscriber to selectively block incoming calls for selected time periods or during programmed time intervals. In this approach, the call screening is again conducted at the telephone company's central office or switching facility.

One more conventional call screening technique is described in U.S. Pat. No. 4,277,649 issued to Sheinbein entitled “Method And Apparatus For Screening Telephone Calls”. In that patent, a telephone system is disclosed in which a called customer or user can screen calls incoming to his station based on the identity of the calling line. The calling line's identity is forwarded to the switching office containing the called customer's screening memory. The memory is interrogated to ascertain the call disposition based on information previously put in the memory by the called customer. In this approach, the screening process is once again dependent on screening conducted at the telephone company's central office or switching facility at which a centralized database is located.

### SUMMARY OF THE INVENTION

The inventive subject matter thus relates to a method for processing a conditional communication from a sending communication device to a receiving communication device, comprising the steps of:

generating emergency indication criteria in the sending communication device;
establishing a communication link between the sending communication device and the receiving communication device;
sending the emergency indication criteria from the sending communication device to the receiving device; and
processing the emergency indication criteria and originating source criteria in the receiving device to determine the operational function or functions to perform, wherein said operational functions comprise: blocking the communication from alerting the user or silencing the communication, using a distinctive alert for reception of the emergency conditional communication, using a non-emergency alert or alerts for reception of a non-emergency conditional communication, using a non-emergency alert or alerts for reception of a non-conditional communication, and terminating the communication.

The inventive subject matter further relates to a method for processing an incoming communication from a sending party to a communications device of a receiving party, comprising the steps of:

setting the receiving party's communication device mode to a conditional communication mode selected from a plurality of device modes, wherein said mode is an emergency conditional communication mode;
receiving an incoming communication that is not an emergency conditional communication; and inhibiting said incoming communication from alerting the receiving party.

The inventive subject matter further relates to an apparatus for processing an incoming communication from a sending party, comprising the following:

a receiving device for receiving an incoming communication;

a processor; and

a memory operably connected to said processor,

wherein said memory is encoded with a stored data file comprising emergency indication criteria and originating source criteria, and

wherein said processor is configured to execute programmed instructions stored in said memory comprising:

receiving emergency indication criteria generated in a sending communication device; and

processing the emergency indication criteria and originating source criteria in the receiving device to determine the operational function or functions to perform, wherein said operational functions comprise: blocking the communication from alerting the user or silencing the communication, using a distinctive alert for reception of the emergency conditional communication, using a non-emergency alert or alerts for reception of a non-emergency conditional communication, using a non-emergency alert or alerts for reception of a non-conditional communication, and terminating the communication.

Accordingly, one aspect of the present inventive subject matter is to provide a method and apparatus for limiting a communications device user's exposure to undesired communications by employing advanced control mechanisms implemented in or near the communications device.

Another aspect of the inventive subject matter is to provide communications device control method and apparatus which permit the consumer to proactively take control of how, when, and if she or he responds to incoming communications.

Yet another aspect of the inventive subject matter is to provide a method and apparatus for transforming a communications device such as a telephone, mobile device, computer, gateway/server, internet device, other communication devices, and/or television, from a passive device to a controllable device that incorporates individual conditional management values and customized consumer priorities.

Yet another aspect of the inventive subject matter is to provide communications device control method and apparatus with a special mode where only an emergency conditional communication is permitted to alert the receiving party.

Yet another aspect of the inventive subject matter is to provide communications device control method and apparatus the capability to record an emergency conditional communication upon that communication being received.

Yet another aspect of the inventive subject matter is to provide a method and apparatus for enterprise-to-person/person-to-person smart emergency communication. This smart emergency communication may be considered a protocol. This smart emergency communication comprises the exchange of an emergency conditional communication indication, the originating party data, and the originating party's location.

Yet another aspect of the inventive subject matter is to provide a method and apparatus for conditional processing of communication wherein the conditional processing at a minimum comprises an emergency condition and a normal condition.

Another aspect of the inventive subject matter is to automate the conditional communication processing where conditional communication processing is comprised of conditions such as an emergency condition, a priority condition from a plurality of possible priorities, for example, emergency, high priority, normal, low priority, etc., and/or a sending party specified condition that can be used to process incoming communication. This conditional processing can be related to the situation to provide the user a situational awareness capability.

In accordance with one embodiment of the present inventive subject matter, a method and apparatus is provided for processing conditional communications wherein a calling party sends a conditional communication to a receiving party's communication device. At a minimum, the method and apparatus comprises a plurality of conditional communications selected from an emergency conditional communication type and a normal conditional communication type. Upon a sending party initiating an emergency communication, such as a placing a call, to a receiving party, a communication link is established between the calling party's device and the receiving communication device. Then an emergency protocol or emergency conditional communication indication is sent from the sending party's device to the receiving party's device. The receiving party's device checks to determine if the incoming communication emergency communication protocol or emergency conditional communication indication is present. If present, the incoming communication is “flagged” as an emergency communication.

This method and apparatus includes optional processing to determine if the identification of the communication originating source is blocked from placing a conditional communication to the receiving party. This includes the step of searching a blocker database of a plurality of identification records to determine if the source, for example a caller, is blocked. If the source is blocked, then the communication is terminated. If the source is not blocked, the method and apparatus sets a distinct alerting signal such as a ringtone used to alert the user of an incoming emergency conditional communication. The receiving party is intelligently alerted they are receiving an emergency communication and not just another call. If the source is not blocked for a normal conditional communication, the method and apparatus sets a regular alerting signal such as a ringtone used to alert the user of a regular incoming communication.

The disclosed method and apparatus includes the step of storing a communication source identification database including a plurality of records. Each record includes the originating source identification, for example caller ID, information corresponding to a particular contact/source, along with the conditional communication type(s) to be blocked.

This method and apparatus additionally includes a special mode which the user can select in their communication device. This mode selectively filters incoming communication by permitting conditional communication of an emergency to alert the receiving party and then with a distinct emergency alert.

All other incoming communication, such as a normal conditional communication, is blocked from alerting the receiving party while the receiving device is in this mode.

This method and apparatus also optionally includes the step of storing a blocking time database including a plurality of records respectively corresponding to the plurality of priorities and further including respective blocking time information for each priority. An incoming communication including caller identification information is received. The time that the incoming communication is received is determined to provide a call received time.

This method and apparatus also optionally includes the option of providing the GPS location, for example latitude and longitude, in the conditional communication protocol of the calling party, which is to be received and displayed by the receiving device.

The caller database is optionally searched to find a record having caller identification information matching the caller identification information of the incoming communication and the respective priority for that record is retrieved to produce a retrieved priority. The blocking time database is searched to determine blocking time information associated with the retrieved priority to produce retrieved blocking time information. The call received time of the incoming communication is compared with the retrieved blocking time information. The method and apparatus further includes the step of blocking the incoming communication if the call received time occurs during a blackout time indicated by the retrieved blocking time information and otherwise permitting the incoming communication to be routed to the user of the communications device. The method and apparatus further optionally includes a step to check if the call being blocked is an emergency call that will be routed according to the consumer pre-selected options.

This method and apparatus also includes the option of recording all emergency communications upon establishing an emergency communication link between the sending and receiving communication devices.

### BRIEF DESCRIPTION OF THE DRAWINGS

The features of the inventive subject matter believed to be novel are specifically set forth in the appended claims. However, the inventive subject matter itself, both as to its structure and method of operation, may best be understood by referring to the following description and accompanying drawings.

FIG. 1 is a functional block diagram showing the overall Communications System;

FIG. 2 is a functional block diagram showing the overall relationship of the disclosed Communications Controller relative to other communication device functions;

FIG. 3 is a block diagram of the hardware needed to support the Communications Controller. The implementation of the hardware can either be as a standalone unit that interfaces to Instantaneous Response Device, Messaging Response Device, and Caller Identification Device functions or an integrated element/feature set;

FIG. 4 depicts a Communications Controller implementation of a user interface;

FIG. 5 is a flow diagram depicting the conditional communication operations and logic;

FIG. 6 is a flow diagram depicting the setting up of the instant blocker function;

FIG. 7 depicts the look-up-table structure, which provides operational settings that are consequential functions related to the incoming caller blocking conditions; and

FIG. 8 depicts notional Protocol Fields as they relate to the Emergency Protocol.

### DETAILED DESCRIPTION OF THE INVENTION

The inventive subject matter thus relates to a method and apparatus for processing a conditional communication from a sending communication device to a receiving communication device, comprising the steps of:

generating emergency indication criteria in the sending communication device;

establishing a communication link between the sending communication device and the receiving communication device;

sending the emergency indication criteria from the sending communication device to the receiving device; and

processing the emergency indication criteria and originating source criteria in the receiving device to determine the operational function or functions to perform,

wherein said operational functions comprise: blocking the communication from alerting the user or silencing the communication, using a distinctive alert for reception of the emergency conditional communication, using a non-emergency alert or alerts for reception of a non-emergency conditional communication, using a non-emergency alert or alerts for reception of a non-conditional communication, and terminating the communication.

The inventive subject matter further relates to an apparatus for processing an incoming communication from a sending party, comprising the following:

a receiving device for receiving an incoming communication;

a processor; and

a memory operably connected to said processor,

wherein said memory is encoded with a stored data file comprising emergency indication criteria and originating source criteria, and

wherein said processor is configured to execute programmed instructions stored in said memory comprising:

receiving emergency indication criteria generated in a sending communication device; and

processing the emergency indication criteria and originating source criteria in the receiving device to determine the operational function or functions to perform, wherein said operational functions comprise: blocking the communication from alerting the user or silencing the communication, using a distinctive alert for reception of the emergency conditional communication, using a non-emergency alert or alerts for reception of a non-emergency conditional communication, using a non-emergency alert or alerts for reception of a non-conditional communication, and terminating the communication.

In one aspect of the inventive subject matter, said method and apparatus further comprises the steps of: searching a database comprising a plurality of records of originating source identification criteria for originating source identification criteria matching a source designated as a blocked source; and upon an originating source identification criteria match, blocking the communication from alerting the receiving party.

In another aspect of the inventive subject matter, said method and apparatus further comprises the step of processing the emergency conditional communication indication using an emergency protocol. In a preferred embodiment, the step of processing the emergency protocol as a setting to indicate that the current communication is an emergency. In another preferred embodiment, the step of processing the emergency protocol includes processing sensor data further comprising the step of processing the emergency protocol which includes sensor data. In a further preferred embodiment, the step of processing the emergency protocol includes processing the location of the sending device. Said location of the sending device optionally comprises its latitude and longitude.

In a further aspect of the inventive subject matter the step of processing the emergency protocol includes activating recording of the communication.

In an alternate aspect of the inventive subject matter, the step of processing the emergency conditional communication indication comprises processing an emergency protocol. In a preferred embodiment, said processing an emergency protocol provides a unique indication in the receiving party's communication device that an emergency communication is being received.

In yet another aspect of the inventive subject matter, said method and apparatus further comprises the steps of: selecting, by the user, an originating source identification to be blocked for emergency conditional communication, and storing said blocked originating source in a memory. In a preferred embodiment, said step of storing is further to a database in said memory.

In another aspect of the inventive subject matter, said method and apparatus further comprises the step of sending the emergency indication criteria as a unique DTMF signal indication.

In a further aspect of the inventive subject matter, said method and apparatus further comprises the steps of: sending the emergency indication criteria as a unique Short Message Service text message to said receiving device; and reading the said Short Message Service text message to determine the emergency conditional communication.

In an alternate aspect of the inventive subject matter, said method and apparatus further comprises the step of sending the emergency indication criteria using Voice-over-Internet Protocol/TCP/IP protocol between the said sending device and the said receiving device.

In another aspect of the inventive subject matter, the sending communication device broadcasts the emergency indication criteria to a plurality of receiving devices simultaneously.

The inventive subject matter further relates to a method for processing an incoming communication from a sending party to a communications device of a receiving party, comprising the steps of:

setting the receiving party's communication device mode to a conditional communication mode selected from a plurality of device modes, wherein said mode is an emergency conditional communication mode;
receiving an incoming communication that is not an emergency conditional communication; and
inhibiting said incoming communication from alerting the receiving party.

The disclosed Communications Controller virtually aids the receiving party to instantly distinguish an incoming emergency communication from the constant disruptions of all other incoming communications, for example phone calls, emails, SMS text messages, IM, spam and/or electronic media. Advantageously, the disclosed communication controller enables consumers to regain value-added control of their personal time and be alerted of critical situations.

For purposes of illustration only, and not to limit generality, the Communications Controller will be explained with reference to its use in processing incoming telephone calls as one example of its application. However, as discussed above, this logic can apply to any media type of incoming communications. The Communications Controller includes automated control logic that intelligently integrates communication routing and screening functions. The controller manages and controls incoming communications depending on the time-of-day, frequency, type, duration, priority rating of the received communication, as well as an automated condition/situation determined by the controller logic, the calling party or originating communication source criteria, and the current mode the receiving party's communication device. The originating source criteria are comprised of appropriate identification of the party, device or entity such as Caller ID, email address, broadcast source, Internet Protocol. address source, website source, internet source, text source, messaging source, Voice-over-Internet Protocol (“VoIP”) source, account identifier, etc.

The disclosed Communications Controller enables the consumer to effectively control the time of day or night that a communication such as a phone call is processed, its associated conditional notification, and if it is permitted to ring/announce an incoming communication to alert the receiving party. It also permits the consumer to establish priorities such as critical/emergency notification for incoming calls. These priorities are then used to automatically route calls through the phone and to the user in a manner that suits the user's specific needs and values. If desired, all normal incoming communications, including unwanted communications from solicitors and harassers, will not even ring. Therefore, at the option of the receiving party, the receiving party is not disturbed, while staying available for only emergency communication. The disclosed controller advantageously transforms the telephone or mobile device into a controllable device which provides efficient and effective timely, value-added communication. It also puts a tool in the user's hands for time-critical emergency situations that are not of a 911 Service nature.

The disclosed communications controller is first described as it functionally relates to other telecommunication device functions. Later, representative hardware for implementing the controller is described in detail along with a description of the processing control logic.

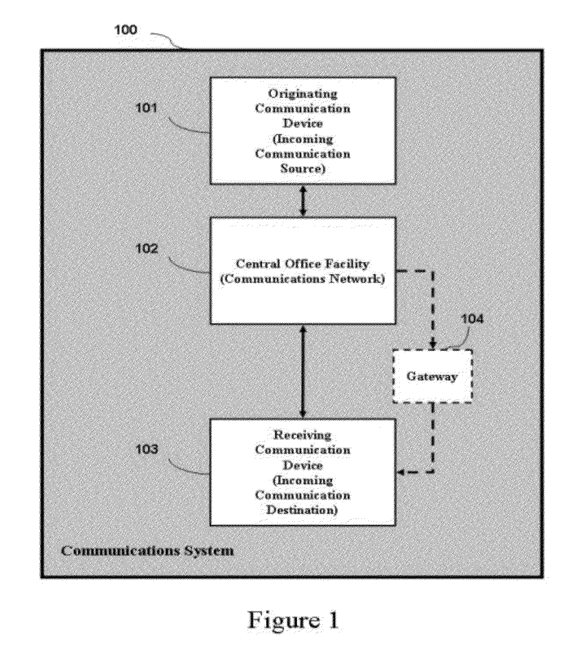

More particularly, FIG. 1 is a functional block diagram showing the overall relationship of the disclosed Communications. The processing provided to a particular incoming telephone call by the Communications Controller is time, incoming call priority, originating source, conditional mode setting, and current receiving device mode setting dependent. System 100 is comprised of the Originating Communication Device or Gateway, alternately referred to as the Incoming Communication source, 101; the Telecommunications Network Service Provider's Central Office Facility, alternately referred to as the Communications Network, 102; and the Receiving Communication Device or Gateway, alternately referred to as the Incoming Communication Destination, 103. A Gateway may comprise a mass notification system capability which could broadcast an emergency alert to one or more receiving parties. A Gateway may also be comprised of a PBX, VoIP, Transmission Control Protocol/Internet Protocol (“TCP/IP”), Hub, Server, Call Center, etc. wherein a Gateway is defined as the function that provides call management/control for multiple users. In this embodiment, the Gateway will be able to process conditional communication as the controller will reside in it as well.

It is noted that the Communications Controller and associative control logic can be applied and implemented as a consumer product along with other consumer communication devices, for example telephones, answering machines/services, Caller ID devices, computers, telephone/television/internet solutions, and mobile/radio devices, network equipment and/or devices such as servers, gateways, PBXs, etc. The Communications Controller can also be implemented at the telephone service switch at the Central Office Facility 102 and provided to the consumer as a communication service.

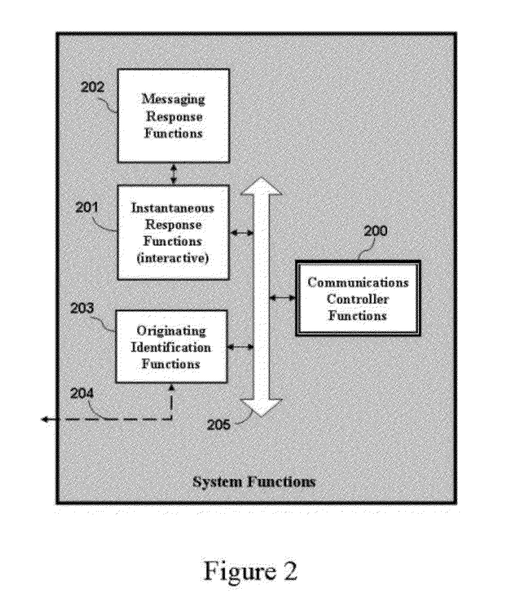

In one embodiment depicted, the Instantaneous Response Device Functions 201, Messaging Response Functions 202, and Caller Identification Functions 203 may be implemented as an integrated device or independently to support the Communications Controller Functions 200 as indicated in FIG. 2.

The Instantaneous Response Device Functions 201, for example a telephone device, provides the interactive support needed for a communications device such as a mobile device/telephone. Examples of the support this device provides are ring/announce, call forward, call waiting, and paging the user for immediate response to the incoming call.

The Messaging Response Functions 202, for example an answering machine, answering service, or recorder, provides the passive support needed for a communications device. Examples of the support this device provides are to play, store, and record message/data, such as voicemail, email, video, multimedia, to which the user can respond at their convenience but not necessarily during the time the call/contact is being placed or made. The communications line 204, for example a telephone line or cable, that connects to other communication devices is coupled to the Caller Identification Functions 203. For a mobile device, the communications line 204 would not be present.

The Originating Identification (“ID”) Function 203 sends incoming communications identification data or originating source criteria such as Caller ID data supplied to the Communications Controller 200. Communications Controller 200 processes incoming communications using for example, the Caller ID data received. Optionally, if the incoming Caller ID data is not available for a particular incoming call, then Communications Controller 200 could use Messaging Response Device, for example Answering Machine, Functions 202 to play an Out Going Message (“OGM”) prompting the caller for their identification data. Upon the Communications Controller 200 attempting to obtain this data, it will continue processing the call. As a result, the Communications Controller 200 will either use: 1) the Instantaneous Response Device Functions 201 to ring/announce via the telephone device, forward the call, page the person being called, support remote control of the device, terminate the call, notify the user of call waiting via a specific beep indication or, 2) the Messaging Response Device 202, for example an Answering Machine, functions to play an appropriate OGM and permit the caller to leave a message.

The interface 205 supports communications to transmit and route data among the above described system functions in FIG. 2.

Originating source criteria can also be originating device dependent, such as an identifier associated to the call origination device, or caller/user dependent, such as an identifier associated to the individual caller/person/account. Consumer products for the Caller Identification Functions 203 using today's technology are device dependent—they provide the caller's phone number and/or name. However, depending on the implementation of the Communications Controller 200, this data could be the I.P. Address of a node on a network, a network identifier, or other device or source identifier data. Conversely, caller dependent Caller ID data can utilize such elements as: 1) Caller account data, such as an account number, email address, Internet address, etc.; 2) Speaker dependent voice data—person identifying themselves by speaking their name in order to capture their temporal phonic signal data; and 3) Video data—a video frame of a caller's unique identifiers, for example biometrics, the caller's face, retinal scan, finger/thumb print, etc.

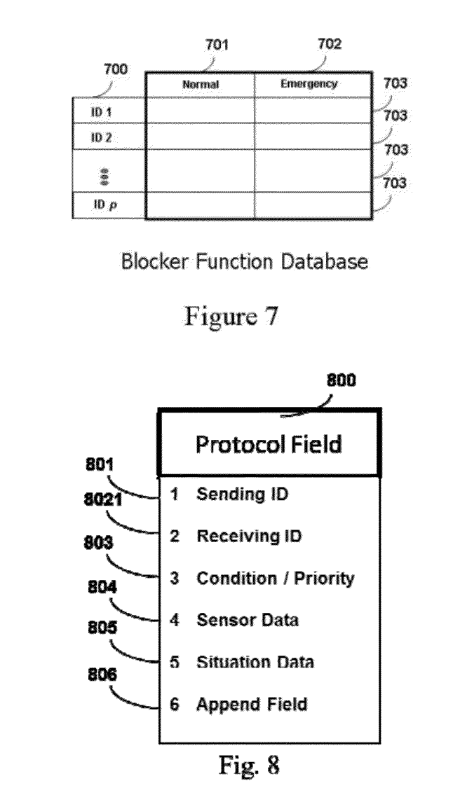

In this embodiment, the Communications Controller 200 is not dependent on the Caller ID data/media type. Rather, controller 200 merely conforms to the data type being used by the Originating Identification (“ID”) Function 203, for example Caller Identification Functions, which is an external interface to Communications Controller 200. Communications Controller 200 merely utilizes this data associated with the caller regardless of its type, for example device dependent or caller dependent, to determine the communication processing dependent on the originating source criteria, for example the caller. Communications Controller 200 uses the incoming Caller ID data to attempt to match this data with the Caller ID data stored in its Blocker Function Database of FIG. 7 for a call processing determination.

The operations of the communications device include the Originating Identification Functions 203, Messaging Response Functions 202, and Instantaneous Response Functions 201. Some of these operations include but are not limited to the following:

provide a specified ring pattern or ringtone or alert, optionally selected from a plurality of ring pattern and alert options, wherein alerts may be aural, visual, and/or tactical;
provide a specified ring pattern or ringtone distinct for emergency conditional communication;
provide a specified announcement for a particular caller;
provide a specified OGM, optionally of multiple OGM options, with or without an opportunity for the caller to leave a message;
terminate the call, for example hang-up without ringing the telephone device;
call Forwarding/paging upon a call being routed to ring and the user pre-selecting this option;
call waiting will transmit a beep signal for the user while on the phone. This beep could be mapped to a priority level beep type to inform the user of the importance of the call prior to them disrupting their present conversation; and
recording an emergency conditional communication.

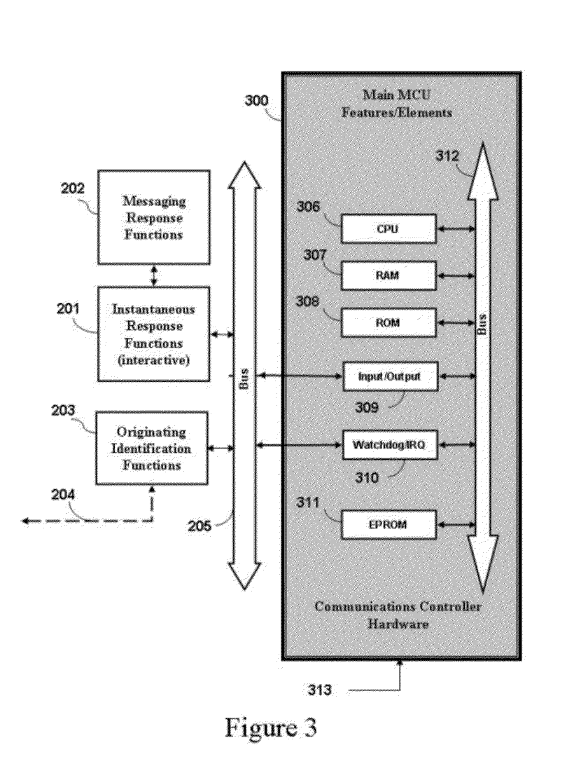

For the purpose of discussion, and not for the purpose of limitation, FIG. 3 depicts a high-level hardware implementation of the FIG. 2 Communications Controller as Communications Controller 300. Controller system 300 employs a microcomputer (“MCU”). Utilization of a MCU for this type of application is a typical solution/implementation. However, the functions indicated in FIG. 2 can be integrated together or packaged separately in numerous configurations. These configurations can range from MCU's to Personal Computer/Internet Systems, personal appliances/devices, or a Radio/Telephony/Television Systems.

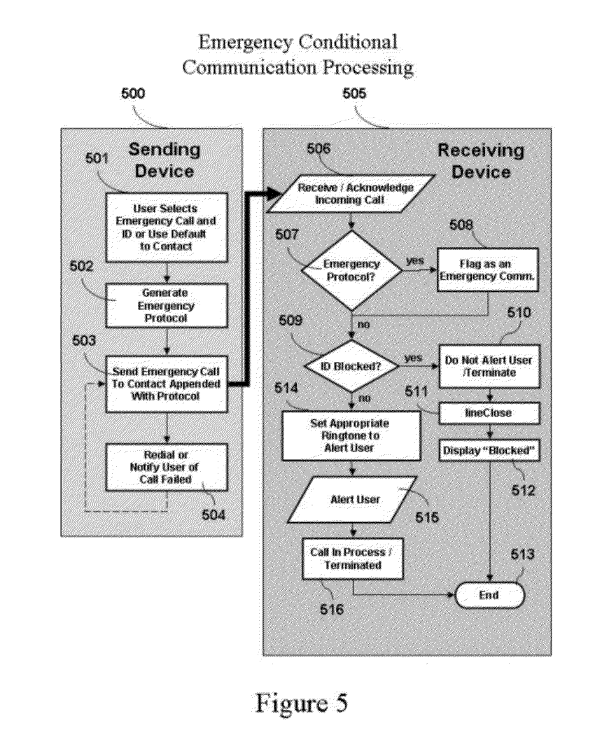

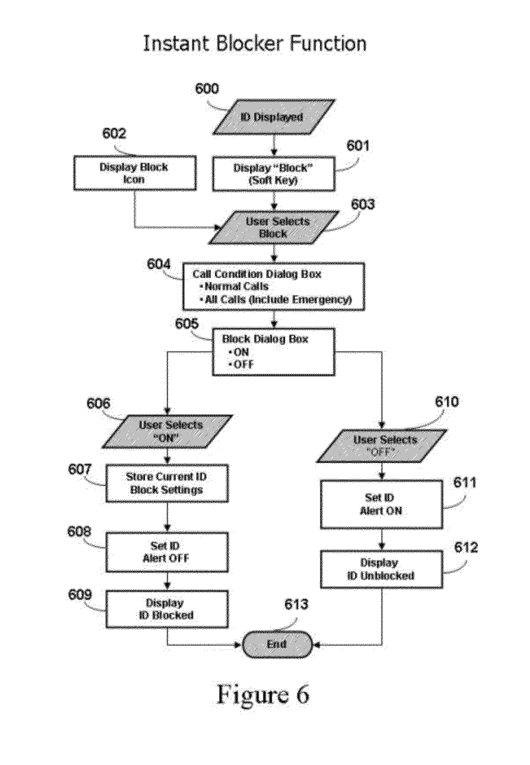

To clearly describe the hardware support functions required for the Communications Controller 300 of FIG. 3, the following example of the steps performed upon receiving a call is explained along with details as they relate to the hardware of Communications Controller 300. Communications Controller 300 is coded with software according to the flow diagrams of FIGS. 5 and 6. This software code is stored in memory within controller 300 in one embodiment. When executed by controller 300, this software causes controller to implement the steps set forth in the flow diagrams of FIGS. 5 and 6.

Data is received and transmitted across the Bus 305 to permit the Instantaneous Response Hardware 301, for example a telephone, the Messaging Response Hardware 302, for example an answering machine, the Caller Identification hardware 303, and Communications Controller 300 to communicate.

Upon receiving a call via the communications line/service 304, the Caller Identification hardware 303 receives the incoming Caller ID data. An interrupt is then generated from the Caller Identification Hardware 303 and sent to the Communications Controller Watchdog/IRQ 310. This Watchdog/IRQ 310, for example an interrupt controller, monitors for reception of an interrupt that designates a communication is being received. After this interrupt, the Caller ID data is transmitted from the Caller Identification Hardware 303 via the bus 305 to the Communications Controller MCU Input port(s) 309. The data is transmitted via the internal Bus 311 to the MCU RAM 307.

This Caller ID data is then compared against data stored in ROM 308 to obtain processing information as explained in the description of FIGS. 5 and 6 flow diagrams. CPU 306 performs the processing software execution, which in turn provides the control logic for the controller according to the described flow diagrams. The RAM/ROM 307/308 provides the memory necessary to support the load of the executable code and memory to support the real-time processing. The ROM 308 provides the storage necessary to support the memory requirements for the database fields of FIG. 7. The internal bus 311 is used to support “local” communications among the various functions within the Communications Controller 300.

In one embodiment, input values such as user selected blocking and setting of the device mode are provided to Communications Controller 300 by the user inputting such selections to the Instantaneous Response Hardware 301, such as a telephone or mobile device. These values are then transmitted to Communications Controller 300 for storage in the memory therein. Alternatively, an input device such as a keyboard device or personal computer can be coupled to communications controller 300 at input port 312 to provide input for such values.

The Communications Controller 200 leverages a special mode or status of the communications device that supports special conditional processing called emergency mode. This mode only permits the reception of an emergency conditional communication to alert the user. For example, if the receiving party selected emergency mode, only an incoming emergency conditional communication would be permitted to ring the device. This ring may be distinctive so the receiving party knows instantly they are receiving an emergency communication. All other “normal” communication is processed as if the intended receiving party did not intercept the communication. The emergency mode may be selected from a plurality of modes provided in the communication device or the selection of the emergency mode may be a toggle setting.

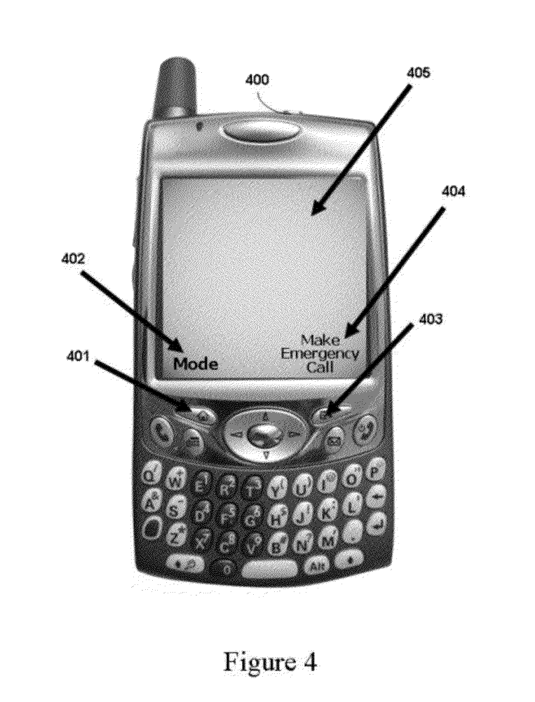

For the purpose of discussion, and not for the purpose of limitation, FIG. 4 depicts a mobile device 400 that has the Communication Controller 300 embedded in it. For example of the user interface design, the soft keys 401, 403 may be programmed to support the functionality of the Communication Controller 200. Pressing soft key 401 permits the user to toggle the emergency mode function on/off. The current mode 402 of the device is displayed on the device screen 405 above the soft key 401.

Programmable key 403 may be used to initiate an emergency call. The Communication Controller 200 functionality for placing an emergency call can be programmed to soft key 403. This functionality is displayed 404 for the user. In a panic situation, the user can merely press or press and hold the Make Emergency Call 403/404 soft key to send an emergency conditional communication. The press and hold function would send a communication to a default/stored contact. A contact list could be used with a scroll capability to allow for easy selection from multiple contacts. Upon just pressing the Emergency Call soft key 403/404, i.e., not press and hold, an opportunity is presented to the user of the device to select or input the phone number/contact information of the party they wish to send an emergency communication. The sending and the receiving devices and/or gateways require the Communication Controller 200 functionality to process an emergency conditional communication as the conditional filtering protocol is used to establish conditional communication between them.

FIGS. 5 and 6 together form a flow diagram depicting the flow of operations carried out by the Communications Controller 200 system. The steps shown in FIGS. 5 and 6 provide an example of the control logic necessary to send and receive communication. Operation commences in the Sending Device 500 where the user places an Emergency Conditional Call 501 achieved by the process described for FIG. 4. Upon selecting the key programmed to send an emergency condition call 403, the Emergency Protocol 502 is generated to be appended to the communication. The call is placed over the network to of at least one or multiple of the selected contact(s) 503. One means to transmit the emergency protocol is to establish a communication connection between the Receiving Device/Gateway 505 and the Sending Device/Gateway and perform a telephone application program interface (“TAPI”) acknowledgement that the communication connection has been accepted then append the communication by sending the Emergency Protocol that was generated 502 to the receiving device 505. TAPI defines standards for simple call control and for manipulating call content. Other means may include sending Short Message Service (“SMS”) messages back and forth between the devices or leveraging Voice over Internet Protocol or TCPIP protocols. Yet another approach might be to generate a signal such as a DTMF string unique to the emergency protocol to be transmitted upon a connection acknowledged from the receiving unit. If the Sending Device 500 does not receive an acknowledgement that the communication has been successfully established with the intended Receiving Device 505, then attempts may be made to redial or just notify the user, i.e. calling party, that the call failed 504.

Upon the Receiving Device 505 receiving a communication, it waits for several cycles, i.e. enough time to permit a protocol to be received, then checks to see if the Emergency Conditional Protocol 507 was received. If received, the call is “flagged” as an Emergency Conditional Communication 508. Then, the originating source criteria which in this embodiment example is Caller ID is used in conjunction with the lookup table of FIG. 7 to determine the device operational function to perform 701, 702 based on the type of communication being received, for example normal communication or emergency conditional communication. If a match of the Caller ID is found in the lookup table 700 for the type of communication being received, then the Caller ID is Blocked 508 so the communication will not alert the user and will terminate 509. Note that the communication could also be forwarded and/or go to voicemail. The TAPI lineclose is performed to terminate the call 510, the Caller ID and “Blocked” are displayed on the receiving party's communication device screen 511, 405 and the Communication Controller 200 process terminates 513.

If the Caller ID is not “Blocked” then, the appropriate alert will be used to notify the receiving of the incoming communication 514. If the incoming communication was flagged as an emergency communication then the Alert User 515 functional process will be a distinct alert uniquely used for only emergency conditional communications. Such unique alert is optionally tactical, aural, or visual. For example, use a special ringtone that is uniquely played only for emergency communications. If no emergency protocol was received, then the incoming communication is considered “normal” and a “normal”, non-emergency, alert will be used to notify 515 the receiving party of the incoming communication event. The Communication Controller 200 process ends upon the call being terminated 516, 513.

Additionally, the Emergency Conditional Communication Processing may optionally comprise of sending location data such as GPS latitude and longitude data from the sending device to the receiving device as part of an emergency communication protocol. This data pinpoints the location of the party in an emergency situation and can be provided to the receiving party in case the sending party is unable to speak. The latitude and longitude data can be displayed on a map in the receiving party's device screen 405.

A communication device enabled with the Communication Controller 200 has an Instant Blocker Function comprised of a flow diagram depicted in FIG. 6. The Instant Blocker function supports the user interface to permit the user to select and set which originating sources are to be blocked for what conditions. For example, upon the Caller ID (“ID”) being displayed on the communication device screen 600, 405 a soft key is programmed to display “Block” 601. Another means to access the Instant Blocker Function may be via an icon displayed on the communication device screen 602, 405. Upon the User Selecting the Block Function 603 of the Communication Controller 200, a Block Dialog Box appears on the display screen 405 along with the current originating source criteria, for example the current Caller ID, with the option to select having only “normal” calls blocked or blocking all calls which includes emergency conditional communication 604. Once this option is selected, another dialog box presents the user of the device the option of toggling the blocking function of the selected condition and Caller ID originating source criteria “ON” or “OFF” 606, 610. If the user selects “ON” 606, store the Current Caller ID and blocking conditions 607 in the Blocker Function Database of FIG. 7, set Caller ID Alert to “OFF” 608 and display the Caller ID and Blocked Status to the user 609, 405. On the other hand, if the user selects “OFF” 610, store the Current Caller ID and blocking conditions 611 in the Blocker Function Database of FIG. 7, set Caller ID Alert to “ON” 612 and display the Caller ID and Unblocked Status to the user 612, 405. The Instant Blocker Function is terminated 613 after the Caller ID Blocked status is displayed 608, 612.

FIG. 7 depicts a representative lookup table structure employed in the disclosed Communications Controller 200. This table is used to determine if a conditional communication, such as normal or emergency condition, for a particular communication originating source or ID 700 is blocked thus not permitted it to disturb the receiving party. The lookup table structure is used by test 508 of FIG. 5 to obtain the consequential operation control data for the integrated communications device functions. These consequences are based on conditional results being present. In particular, the lookup table structure includes a plurality of records 703 designated 1 . . . p, which is dependent on the number of ID's employed in a particular embodiment of Communications Controller 700. In the disclosed embodiment, the ID is comprised of the originating source criteria such as the Caller ID.

With the combined conditions of the call being placed as an emergency conditional communication and the incoming ID being blocked 702, the desired consequential operation of the communication device is defined as blocked. Again, with the combined conditions of the call being placed as a normal communication and the ID of the incoming call being blocked 701, the desired consequential operation of the telephone device is defined as blocked. If the communication is defined as blocked, it will not be permitted to alert the receiving party that they are receiving an incoming communication. This function permits the receiving party to control which originating source/caller can “ring” their communications device, thus alerting them. If the ID 700 of the originating source is not present in the Blocker Function Database, it is considered acceptable to alert or “ring” the receiving party notifying them of the incoming communication.

FIG. 8 depicts notional protocol fields 800 to support the Sending Device logic of “Generate Emergency Protocol” 502. These fields may comprise but not be limited to the Sending ID 801 for the originating source identification; the Receiving ID 802 for the intended party's identification data; the Condition and/or Priority of the communication 803 wherein there may be various levels of emergency or priority communication, for example emergency-highest priority, high priority-middle priority, normal-no priority; Sensor Data 804 for readings of sensors data wherein a sensor may be a GPS so the location and/or NEMA data would be used in the sensor filed; Situation Data 805 where situation awareness information may be embedded, for example red alert—school is in lock-down; and an Append Field 806 wherein additional data may be added to the protocol.

While a method and apparatus for controlling incoming communications has been described above, it is clear a communications system for processing incoming communications which include caller identification information is also disclosed. In summary, the disclosed system includes a caller identification device for receiving the incoming communication and extracting caller identification information from the incoming communication. The system also includes a user communications device for receiving and providing an incoming communication to a user of the communications device. The system further includes a communications controller coupled between the caller identification device and the user communications device. In one embodiment, the controller includes a processor for executing code to control the transmission of incoming communications to the user communications device. The controller further includes a memory for storing code for execution by the processor to control the transmission of incoming communications to the communications device. The stored code includes a caller database having a plurality of records, each record including caller identification information corresponding to a particular caller and a respective priority selected from a plurality of priorities. The stored code also includes a blocking time database having a plurality of records respectively corresponding to the plurality of priorities and including respective blocking time information for each priority. As discussed earlier in detail, depending on the time that a particular incoming communication is received and which of the plurality of priorities it is accorded, the communication is blocked, permitted or other appropriate action is taken.

In summary, the disclosed method and apparatus advantageously limits a communications device user's exposure to undesired communications by employing advanced control mechanisms implemented at or near the communications device in one embodiment. The control method and apparatus permits the consumer to proactively take control of how, to what conditions, and if the customer responds to incoming communications. Advantageously, the disclosed method transforms the communications device, for example telephone, computer, internet device, and/or television, from a passive device to a “smart” controllable device that incorporates individual time management values and customized consumer priorities. It empowers the user to know instantly that they are not just receiving another “normal” communication but an “emergency” condition communication. Incoming communications are managed and controlled depending on the time of day, frequency, type, originating source criteria, the condition the communication, priority rating of the particular communications being received, and the current mode of the device. A special mode is provided wherein only emergency condition communication can alert the receiving party, while all other communication is silenced/terminated. In this manner, the user is empowered to take control over incoming communications and always stay selectively/intelligently connected in case an emergency or critical situation arises. This is especially useful in situations where it is desired to have your mobile device turned “OFF”.

While only certain preferred features of the inventive subject matter have been shown by way of illustration, many modifications and changes will occur to those skilled in the art. It is, therefore, to be understood that the present claims are intended to cover all such modifications and changes which fall within the true spirit of the inventive subject matter

1. A method for processing a conditional communication from a sending communication device to a receiving communication device, comprising the steps of:
generating emergency indication criteria in the sending communication device;
establishing a communication link between the sending communication device and the receiving communication device;
sending the emergency indication criteria from the sending communication device to the receiving device; and
processing the emergency indication criteria and originating source criteria in the receiving device to determine the operational function or functions to perform,
wherein said operational functions comprise: blocking the communication from alerting the user or silencing the communication, using a distinctive alert for reception of the emergency conditional communication, using a non-emergency alert or alerts for reception of a non-emergency conditional communication, using a non-emergency alert or alerts for reception of a non-conditional communication, and terminating the communication.

2. The method of claim 1, further comprising the steps of:
searching a database comprising a plurality of records of originating source identification criteria for originating source identification criteria matching a source designated as a blocked source; and
upon an originating source identification criteria match, blocking the communication from alerting the receiving party.

3. The method of claim 1, further comprising the step of processing the emergency conditional communication indication using an emergency protocol.

4. The method of claim 3, further comprising the step of processing the emergency protocol as a setting to indicate that the current communication is an emergency.

5. The method of claim 3, wherein the step of processing the emergency protocol includes processing sensor data further comprising the step of processing the emergency protocol which includes sensor data.

6. The method of claim 5, wherein the step of processing the emergency protocol includes processing the location of the sending device.

7. The method of claim 6, wherein the location of the sending device comprises its latitude and longitude.

8. The method of claim 3, wherein the step of processing the emergency protocol includes activating recording of the communication.

9. The method of claim 3, wherein the step of processing the emergency conditional communication indication comprises processing an emergency protocol.

10. The method of claim 9, wherein said processing an emergency protocol provides a unique indication in the receiving party's communication device that an emergency communication is being received.

11. The method of claim 1, further comprising the steps of:
selecting, by the user, an originating source identification to be blocked for emergency conditional communication, and
storing said blocked originating source in a memory.

12. The method of claim 11, wherein said step of storing is further to a database in said memory.

13. The method of claim 1, further comprising the step of sending the emergency indication criteria as a unique DTMF signal indication.

14. The method of claim 1, further comprising the steps of:
sending the emergency indication criteria as a unique Short Message Service text message to said receiving device; and
reading the said Short Message Service text message to determine the emergency conditional communication.

15. The method of claim 1, further comprising the step of sending the emergency indication criteria using Voice-over-Internet Protocol/TCP/IP protocol between the said sending device and the said receiving device.

16. The method of claim 1, wherein the sending communication device broadcasts the emergency indication criteria to a plurality of receiving devices simultaneously.

17. A method for processing an incoming communication from a sending party to a communications device of a receiving party, comprising the steps of:
setting the receiving party's communication device mode to a conditional communication mode selected from a plurality of device modes, wherein said mode is an emergency conditional communication mode;
receiving an incoming communication that is not an emergency conditional communication; and
inhibiting said incoming communication from alerting the receiving party.

18. An apparatus for processing an incoming communication from a sending party, comprising the following:
a receiving device for receiving an incoming communication;
a processor; and
a memory operably connected to said processor,
wherein said memory is encoded with a stored data file comprising emergency indication criteria and originating source criteria, and
wherein said processor is configured to execute programmed instructions stored in said memory comprising:
receiving emergency indication criteria generated in a sending communication device; and
processing the emergency indication criteria and originating source criteria in the receiving device to determine the operational function or functions to perform, wherein said operational functions comprise: blocking the communication from alerting the user or silencing the communication, using a distinctive alert for reception of the emergency conditional communication, using a non-emergency alert or alerts for reception of a non-emergency conditional communication, using a non-emergency alert or alerts for reception of a non-conditional communication, and terminating the communication.

19. The apparatus of claim 18, wherein said program instructions further comprise the steps of:
searching a database comprising a plurality of records of originating source identification criteria for originating source identification criteria matching a source designated as a blocked source; and
upon an originating source identification criteria match, blocking the communication from alerting the receiving party.

20. The apparatus of claim 18, wherein said program instructions further comprise the step of processing the emergency conditional communication indication using an emergency protocol.

21. The apparatus of claim 20, wherein said program instructions further comprise the step of processing the emergency protocol as a setting to indicate that the current communication is an emergency.

22. The apparatus of claim 20, wherein the step of processing the emergency protocol includes processing sensor data further comprising the step of processing the emergency protocol which includes sensor data.

23. The apparatus of claim 22, wherein the step of processing the emergency protocol includes processing the location of the sending device.

24. The apparatus of claim 23, wherein the location of the sending device comprises its latitude and longitude.

25. The apparatus of claim 20, wherein the step of processing the emergency protocol includes activating recording of the communication.

26. The apparatus of claim 20, wherein the step of processing the emergency conditional communication indication comprises processing an emergency protocol.

27. The apparatus of claim 26, wherein said processing an emergency protocol provides a unique indication in the receiving party's communication device that an emergency communication is being received.

28. The apparatus of claim 18, further comprising the steps of:
selecting, by the user, an originating source identification to be blocked for emergency conditional communication, and
storing said blocked originating source in a memory.

29. The apparatus of claim 28, wherein said step of storing is further to a database in said memory.

30. The apparatus of claim 18, further comprising the step of sending the emergency indication criteria as a unique DTMF signal indication.

31. The apparatus of claim 18, further comprising the steps of:
sending the emergency indication criteria as a unique Short Message Service text message to said receiving device; and
reading the said Short Message Service text message to determine the emergency conditional communication.

32. The apparatus of claim 18, further comprising the step of sending the emergency indication criteria using Voice-over-Internet Protocol/TCP/IP protocol between the said sending device and the said receiving device.

33. The apparatus of claim 18, wherein the sending communication device broadcasts the emergency indication criteria to a plurality of receiving devices simultaneously.
